(19) United States
(12) Patent Application Publication
(10) Pub. No.: US 2024/0391443 A1
(43) Pub. Date: Nov. 28, 2024

(54) ELECTRO-MECHANICAL BRAKE AND METHOD FOR OPERATING THE SAME

(71) Applicant: HL MANDO CORPORATION, Gyeonggi-do (KR)

(72) Inventors: Younghun KONG, Gyeonggi-do (KR); Jinseok KIM, Gyeonggi-do (KR); Woochul LIM, Gyeonggi-do (KR); Daejune JUNG, Gyeonggi-do (KR)

(21) Appl. No.: 18/671,280

(22) Filed: May 22, 2024

(30) Foreign Application Priority Data
May 22, 2023 (KR) 10-2023-0065666

(51) Int. Cl. B60T 13/74; B60T 8/17; F16D 65/18; F16D 121/24; F16D 125/48; F16D 127/06

(52) U.S. Cl. CPC B60T 13/746; B60T 8/17; F16D 65/18; F16D 2121/24; F16D 2125/48; F16D 2127/06

(57) ABSTRACT

An electromechanical brake may include a gear configured to provide power for braking when rotating in one direction and to provide power for releasing a braking state when rotating in the other direction, and having one or more grooves; a detent housing; a detent pivotably coupled to the detent housing to pivot between a first position and a second position, wherein the detent does not limit the rotation of the gear at the first position and the detent is engaged with the groove to limit the rotation of the gear at the second position; an actuator configured to cause the detent to be pivoted from the first position to the second position; and an elastic member configured to press the detent in a direction from the second position toward the first position.

### CROSS-REFERENCE TO RELATED APPLICATION

This application claims priority to and the benefit from Korean Patent Application No. 10-2023-0065666, filed on May 22, 2023, the disclosure of which is incorporated herein by reference in its entirety.

### BACKGROUND

### 1. Technical Field

The present disclosure generally relates to an electromechanical brake and a method of operating the same, and more particularly, to an electromechanical brake configured to generate braking force according to driving of a motor and a method of operating the same.

### 2. Discussion of Related Art

A brake is an apparatus for reducing the speed of a vehicle or maintaining a stationary state of the vehicle. More specifically, the brake serves to limit the rotation of the wheels of the vehicle.

Recently, an electro-mechanical brake (EMB) system that electronically controls the operation of the brake has been developed. These electromechanical brakes may be capable of being operated not only manually by the driver but also automatically through autonomous electronic control. Therefore, electro-mechanical brakes facilitate the automation of vehicles.

The electromechanical brake is configured to convert the torque of an actuator into parking braking force during a parking braking operation.

Meanwhile, for safety reasons, it is necessary to prevent unintentional release of the parking braking state after the vehicle is parked. Therefore, the electro-mechanical brake has a locking mechanism in order to prevent the parking brake from being released when the vehicle is in the parking braking state.

### SUMMARY

According to some embodiments of the present disclosure, an electromechanical brake and a method for operating the same may provide the reliable and stable displacement of a detent that prevents a gear, which transmits the torque of an actuator, from rotating in a direction of releasing parking brake.

In addition, according to certain embodiments of the present disclosure, an electromechanical brake and a method for operating the same may stably perform the pivoting of a detent along a consistent path in order to prevent the rotation of a gear, which generates braking force during a parking brake operation, in a direction of releasing parking brake.

The objects of the present disclosure are not limited to the above-described objects, and other objects that are not mentioned will be able to be clearly understood by those skilled in the art to which the present disclosure pertains from the following description.

According to an aspect of the present disclosure, provided is an electromechanical brake, including a gear arranged to provide power for braking when rotating in one direction and to provide power for releasing the braking state when rotating in the other direction, and having one or more grooves; a detent housing; a detent that is coupled to the detent housing to pivot between a first position and a second position, does not limit the rotation of the gear in the first position and engages with the groove in the second position to limit the rotation of the gear; an actuator that pivots the detent from the first position to the second position; and an elastic member arranged to press the detent in a direction from the second position toward the first position.

In this case, in the electromechanical brake according to an aspect of the present disclosure, the detent may include a detent body having a predetermined length and a detent hole penetrating the detent body in the transverse direction.

In addition, the electromechanical brake according to an aspect of the present disclosure may further include a detent pin arranged through the hole and coupled to the detent housing, and the detent pin may be a pivot shaft of the detent.

In addition, in the electromechanical brake according to an aspect of the present disclosure, the pivot shaft of the detent may be arranged to pass through the detent in the transverse direction.

In addition, in the electromechanical brake according to an aspect of the present disclosure, the detent may include an inclined portion at one end in the longitudinal direction that engages with the groove in the second position.

In addition, in the electromechanical brake according to an aspect of the present disclosure, the inclined portion may have a shape in which the distance from the pivot shaft of the detent increases as it approaches one surface of the detent facing the gear.

In addition, in the electromechanical brake according to an aspect of the present disclosure, the detent may have a chamfering portion at an edge between one end in the longitudinal direction that engages with the groove at the second position and one surface facing the gear.

In addition, in the electromechanical brake according to an aspect of the present disclosure, the elastic member may include a first fixing part coupled to a pivot shaft of the detent on one side of the detent in the traverse direction, a second fixing part coupled to the pivot shaft on the other side of the detent in the traverse direction, and a connection part extending to connect the first fixing part and the second fixing part to each other and pressing one surface of the detent facing the gear.

In addition, in the electromechanical brake according to an aspect of the present disclosure, the detent may have a detent groove into which the connection part is inserted and seated on one surface of the detent facing the gear.

In addition, in the electromechanical brake according to an aspect of the present disclosure, the detent groove may be arranged transversely across the detent.

In addition, in the electromechanical brake according to an aspect of the present disclosure, the detent housing may include a housing body, a first sidewall connected to the housing body and coupled to one end of a pivot shaft of the detent, and a second sidewall connected to the housing body and coupled to the other end of the pivot shaft.

In addition, in the electromechanical brake according to an aspect of the present disclosure, the detent housing may further include a pivot guide provided in the housing body to accommodate a portion of the detent away from the gear and guide the pivot when the detent pivots from the first position to the second position around the pivot shaft.

In addition, according to another aspect of the present disclosure, provided is an electromechanical brake, including a gear arranged to provide power for braking when rotating in one direction and to provide power for releasing the braking state when rotating in the other direction, and having one or more grooves; a motor that supplies rotational force to the gear; a detent housing; a detent that is coupled to the detent housing to pivot between a first position and a second position, does not limit the rotation of the gear in the first position and engages with the groove in the second position to limit the rotation of the gear; an actuator that pivots the detent from the first position to the second position; an elastic member arranged to press the detent in a direction from the second position toward the first position; and a controller that controls the motor and the actuator.

In this case, in the electromechanical brake according to another aspect of the present disclosure, the pivot shaft of the detent may be arranged to pass through the detent in the transverse direction.

In addition, in the electromechanical brake according to another aspect of the present disclosure, the detent may include an inclined portion at one end in the longitudinal direction that engages with the groove in the second position.

In addition, in the electromechanical brake according to another aspect of the present disclosure, the inclined portion may have a shape in which the distance from the pivot shaft of the detent increases as it approaches one surface of the detent facing the gear.

In addition, in the electromechanical brake according to another aspect of the present disclosure, the detent may have a chamfering portion at an edge between one end in the longitudinal direction that engages with the groove at the second position and one surface facing the gear.

In addition, in the electromechanical brake according to another aspect of the present disclosure, the elastic member may include a first fixing part coupled to a pivot shaft of the detent on one side of the detent in the traverse direction, a second fixing part coupled to the pivot shaft on the other side of the detent in the traverse direction, and a connection part extending to connect the first fixing part and the second fixing part to each other and pressing one surface of the detent facing the gear.

In addition, in the electromechanical brake according to another aspect of the present disclosure, the detent may have a detent groove into which the connection part is inserted and seated on one surface of the detent facing the gear.

In addition, in the electromechanical brake according to another aspect of the present disclosure, the detent groove may be arranged transversely across the detent.

In addition, in the electromechanical brake according to another aspect of the present disclosure, the detent housing may include a housing body, a first sidewall connected to the housing body and coupled to one end of a pivot shaft of the detent, and a second sidewall connected to the housing body and coupled to the other end of the pivot shaft.

In addition, in the electromechanical brake according to another aspect of the present disclosure, the detent housing may further include a pivot guide provided in the housing body to accommodate a portion of the detent away from the gear and guide the pivot when the detent pivots from the first position to the second position around the pivot shaft.

In addition, in the electromechanical brake according to another aspect of the present disclosure, the controller may be configured to control the motor during parking braking to rotate the gear in one direction to generate braking force, control the motor to rotate the gear to a predetermined degree in the other direction after parking braking is completed, and control the actuator to pivot the detent from the first position to the second position such that the detent engages with the groove.

In addition, in the electromechanical brake according to another aspect of the present disclosure, the controller may be configured to control the motor when the parking braking is released to rotate the gear to a predetermined degree in one direction so that the engagement between the detent and the groove is released and the detent is pivoted to the first position by the elastic member.

According to yet another aspect of the present disclosure, provided is a method for operating an electromechanical brake, the electromechanical brake, including: a gear arranged to provide power for braking when rotating in one direction and to provide power for releasing the braking state when rotating in the other direction, and having one or more grooves; a motor that supplies rotational force to the gear; a detent housing; a detent that is coupled to the detent housing to pivot between a first position and a second position, does not limit the rotation of the gear in the first position and engages with the groove in the second position to limit the rotation of the gear; an actuator having a pin to pivot the detent from the first position to the second position by displacing the pin from a non-protruding position to a protruding position; and an elastic member arranged to press the detent in a direction from the second position toward the first position, the method including: to activate parking braking mode, rotating the gear in one direction according to the operation of the motor to generate braking force; rotating the gear at a predetermined angle in the other direction according to the operation of the motor; pivoting the detent from the first position to the second position by displacing the pin from a non-protruding position to a protruding position according to the operation of the actuator; and displacing the pin from a protruding position to a non-protruding position according to the operation of the actuator.

The method for operating an electromechanical brake according to yet another aspect of the present disclosure may include: to deactivate the parking braking mode after activating the parking braking mode, rotating the gear in one direction according to the operation of the motor; disengaging the detent from the groove and pivoting the detent from the second position to the first position by the pressing force of the elastic member; and rotating the gear in the other direction according to the operation of the motor so that the braking force is released.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of an electromechanical brake according to an exemplary embodiment of the present disclosure.

FIG. 2 is a top view illustrating an electromechanical brake without a second housing according to an exemplary embodiment of the present disclosure.

FIG. 3 is a perspective view illustrating an electromechanical brake without a second housing and a controller according to an exemplary embodiment of the present disclosure.

FIG. 4 is a perspective view illustrating a gear, detent housing, detent, actuator, and elastic member of an electromechanical brake according to an exemplary embodiment of the present disclosure.

FIG. 5 is an perspective view of a gear of an electromechanical brake according to an exemplary embodiment of the present disclosure.

FIG. 6 is a partially exploded view illustrating a detent housing, detent, actuator, and elastic member of an electromechanical brake according to an exemplary embodiment of the present disclosure.

FIG. 7 is a partially cut view illustrating a detent housing, detent, actuator, and elastic member of an electromechanical brake according to an exemplary embodiment of the present disclosure.

FIG. 8 is a view illustrating a disengaged arrangement in which a detent is disengaged from a gear in an electromechanical brake when the detent is positioned at a first position according to an exemplary embodiment of the present disclosure.

FIG. 9 is a view illustrating an engaged arrangement in which a detent is engaged with a gear in an electromechanical brake when the detent is positioned at a second position according to an exemplary embodiment of the present disclosure.

FIGS. 10 to 13 are views illustrating an operation process during parking braking of an electromechanical brake according to an exemplary embodiment of the present disclosure.

FIGS. 14 to 16 are views illustrating an operation process during releasing of parking braking of an electromechanical brake according to an exemplary embodiment of the present disclosure.

FIG. 17 is a flowchart for illustrating a method for operating an electromechanical brake according to an exemplary embodiment of the present disclosure.

FIG. 18 is a flowchart for illustrating a step of activating a parking mode in a method for operating an electromechanical brake according to an exemplary embodiment of the present disclosure.

FIG. 19 is a flowchart illustrating a step of deactivating parking mode in a method for operating an electromechanical brake according to an exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

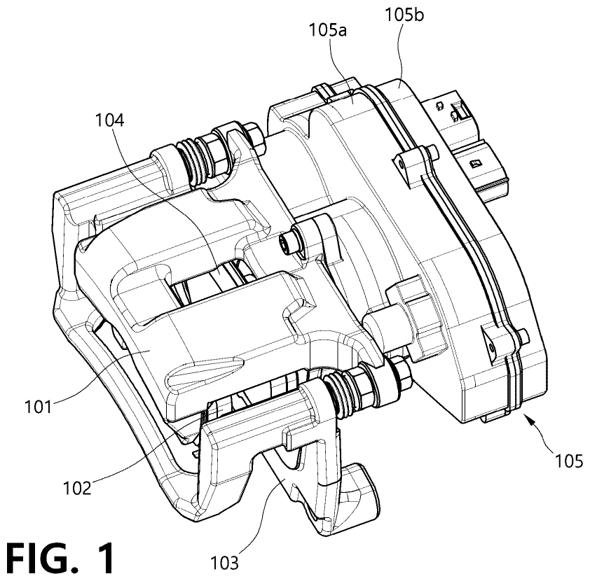

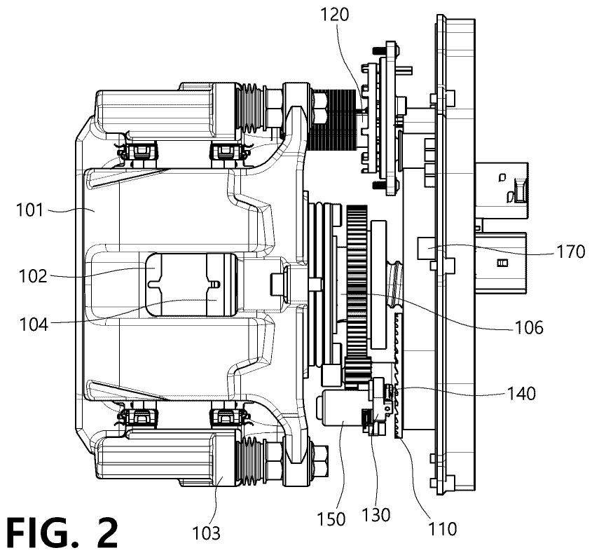

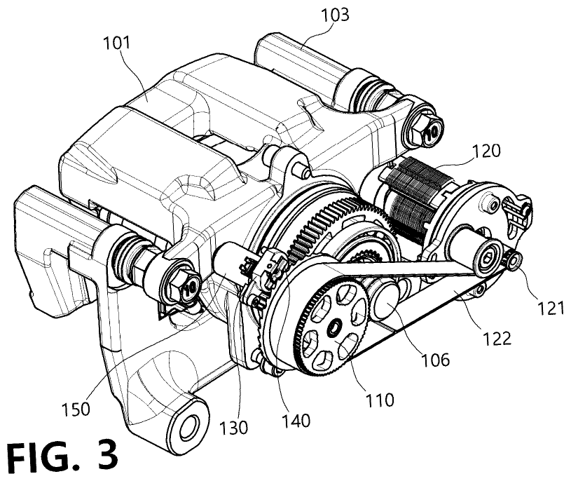

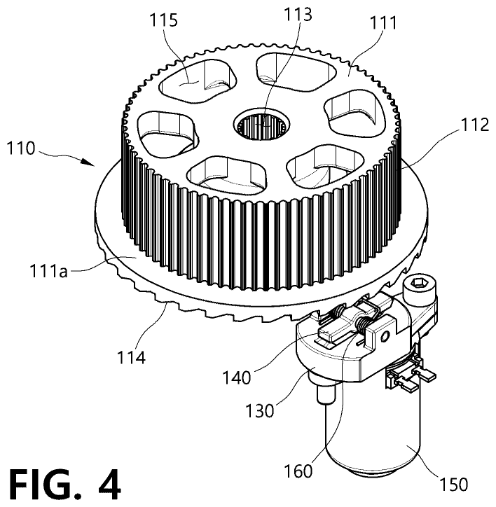

FIG. 1 is a perspective view of an electromechanical brake according to an exemplary embodiment of the present disclosure. FIG. 2 is a top view illustrating an electromechanical brake without a second housing according to an exemplary embodiment of the present disclosure. FIG. 3 is a perspective view illustrating an electromechanical brake without a second housing and a controller according to an exemplary embodiment of the present disclosure. FIG. 4 is a perspective view illustrating a gear, detent housing, detent, actuator, and elastic member of an electromechanical brake according to an exemplary embodiment of the present disclosure.

An electromechanical brake 100 according to an embodiment of the present disclosure may be configured to generate a braking force in an electromechanical manner. For example, the electromechanical brake 100 according to an embodiment of the present disclosure may include a motor 120 configured to generate a braking force during driving or parking of a vehicle.

The electromechanical brake 100 according to an embodiment of the present disclosure may include a first housing 101, a first brake pad 102 coupled to the first housing 101, a carrier 103 movably coupled to the first housing 101 so as to be relatively displaceable with respect to the first housing 101, and a second brake pad 104 coupled to the carrier 103. The first brake pad 102 and the second brake pad 104 may be disposed to face each other. In addition, a disk or rotor coupled to a wheel of the vehicle and configured to rotate together with the wheel may be rotatably disposed between the first brake pad 102 and the second brake pad 104.

Hereinafter, for illustration purposes only, the orientation is defined as that the first brake pad 102 is disposed in front of the second brake pad 104. When referring a relative position between certain components in the present disclosure, a component disposed closer to the first brake pad 102 may be mentioned to be disposed in front of a component disposed relatively further away from the first brake pad 102. In other words, in the present disclosure, a component disposed at the relatively farther away from the first brake pad 102 may be mentioned to be disposed at the rear compared to a component disposed relatively closer to the first brake pad 102.

When the carrier 103 is displaced forward with respect to the first housing 101, a distance between the first brake pad 102 and the second brake pad 104 may be closer in order to press the disk for performing braking. In addition, when the carrier 103 is displaced rearward with respect to the first housing 101, a distance between the first brake pad 102 and the second brake pad 104 may be widened to release the braking.

In an embodiment of the present disclosure, a second housing 105 may be coupled to the rear of the first housing 101. The second housing 105 may include a second housing body 105a in which a driving mechanism 106 for displacing the carrier 103 is disposed and a second housing cover 105b covering the open rear of the second housing body 105a. and the second housing cover 105b is coupled to the second housing body 105a.

The driving mechanism 106 may be coupled to displace the carrier 103. For example, the driving mechanism 106 may include a ball-screw mechanism having a ball screw, a nut, and the like. However, the present disclosure is not limited thereto, and the driving mechanism may include any mechanism capable of converting a rotational force to a linear movement. In an embodiment of the present disclosure, a rotational force of a motor 120 is transmitted to the driving mechanism 106 through a gear 110, and the carrier 103 is displaced according to the operation of the driving mechanism 106 to perform the braking operation.

Referring to FIGS. 1 to 4, the electromechanical brake 100 according to an embodiment of the present disclosure may include one or more of a gear 110, a motor 120, a detent housing 130, a detent 140, an actuator 150, an elastic member 160, and a controller 170. In an embodiment of the present disclosure, the gear 110, the motor 120, the detent housing 130, the detent 140, the actuator 150, the elastic member 160, and the controller 170 may be disposed inside the second housing 105, although not required.

The gear 110 is configured or arranged to transmit or provide power for applying the brake when rotating in one direction and to provide power for releasing the brake when rotating in the other direction. In an embodiment of the present disclosure, the gear 110 receives a rotational force from the motor 120 and transmits the rotational force to the driving mechanism 106. When the gear 110 rotates in one direction, the driving mechanism 106 may operate in a direction of applying a braking force, and when the gear 110 rotates in the other direction, the driving mechanism 106 may operate in a direction of releasing the braking force.

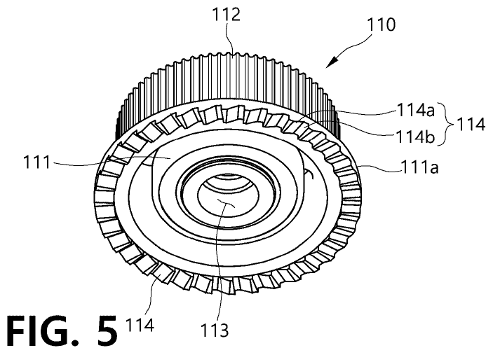

FIG. 5 is an perspective view of a gear of an electromechanical brake according to an exemplary embodiment of the present disclosure.

Referring to FIG. 5, the gear 110 may include a gear body 111, a gear teeth 112, a shaft coupling portion 113, and a groove 114.

The gear body 111 may have substantially a disk shape. In an embodiment of the present disclosure, the gear body 111 may have a flange 111a extending radially outward from one end surface in the longitudinal direction. For example, a diameter of the flange 111a may be larger than a diameter of the gear body 111. One or grooves 114 to be described later may be formed on the flange 111a. In this way, as the groove 114 is formed on the flange 111a having a diameter greater than the diameter of the gear body 111, the torque generated when the detent 140 is engaged with the groove 114 may be increased.

The gear teeth 112 may be formed on the outer circumferential surface of the gear body 111. The gear 110 may be operably connected to the motor 120. For example, the gear teeth 112 may be directly or indirectly coupled to the output shaft of the motor 120 and be engaged with a belt 122 configured to transmit the rotational force of a rotating driving gear 121 to the gear 110. In other words, the driving force of the motor 120 may be transmitted to the driving gear 121 coupled to the output shaft of the motor 120, and the transmitted rotational force of the driving gear 121 may be transmitted to the gear 110 by the belt 122 connecting between the driving gear 121 and the gear 110.

The shaft coupling portion 113 is formed in the gear body 111 so that the rotation shaft of the gear 110 is coupled to the shaft coupling portion 113 of the gear 110. In an embodiment of the present disclosure, the shaft coupling portion 113 may be formed as a coupling hole penetrating the center of the gear body 111 in the longitudinal direction. A rotation shaft of the gear 110 may be coupled to the shaft coupling portion 113, and a transmission gear configured to transmit a rotational force of the gear 110 to the driving mechanism 106 may be coupled onto the rotation shaft coupled to the shaft coupling portion 113.

One or more grooves 114 are formed on the gear body 111. In an embodiment of the present disclosure, the groove 114 may be disposed on an end surface of the gear body 111 facing the detent 140 among both ends of the gear body 111 in the longitudinal direction. A plurality of grooves 114 may be formed at regular intervals along the circumferential direction.

As described above, the groove 114 may be formed on the flange 111a extending radially outward from one end surface of the gear body 111 in the longitudinal direction of the gear body 111. The diameter of the flange 111a is larger than the diameter of the gear body 111. Therefore, by forming the groove 114 on the flange 111a of the gear 110, the torque caused by the engagement of the groove 114 and the detent 140 may be increased.

In an embodiment of the present disclosure, the groove 114 may include an inclined recessed portion 114a recessed obliquely at a first angle from one end surface of the gear body 111 in the longitudinal direction, and a fastening wall 114b formed at a second angle from one end of the inclined recessed part 114a in the recessed direction. Here, the first angle may be defined as an angle formed by the longitudinal one end surface of the gear body 111 and the inclined recessed portion 114a, and the second angle may be defined as an angle formed by the longitudinal one end surface of the gear body 111 and the fastening wall 114b.

In this case, the first angle is smaller than the second angle. In other words, the second angle is greater than the first angle. For example, the second angle may be formed between 80 and 90 degrees with respect to one end surface of the gear body 111 in the longitudinal direction so that the engagement between the detent 140 and the groove 114 of the gear 110 can be securely maintained when the parking brake is applied.

The inclined recessed portion 114a allows the detent 140 to be pivoted from the first position (e.g. a disengaged position) to the second position (e.g. an engaged position) to smoothly inserted into one of the grooves 114. In addition, the fastening wall 114b allows the detent 140 to be stably engaged with the groove 114 at the second position (e.g. an engaged position).

Referring to FIG. 4, the gear 110 may have one or more hollow portions 115 formed in the gear body 111. The hollow portions 115 may reduce the weight of the gear 110 to increase the driving efficiency of the gear 110. The hollow portions 115 may be symmetrically formed with respect to the rotation shaft of the gear 110 for maintaining the balance during the rotation of the gear 110.

The motor 120 supplies rotational force to the gear 110. The motor 120 may operate by the control of the controller 170. The motor 120 is not limited to a specific type motor, and both DC type motors and AC type motors can be used, provided that the required braking force can be generated.

As described above, in an embodiment of the present disclosure, the driving force of the motor 120 may be transmitted to the driving gear 121 coupled or mounted to the output shaft of the motor 120, and the rotational force of the driving gear 121 may be transmitted to the gear 110 by the belt 122 connecting between the driving gear 121 and the gear 110.

The detent 140 is movably or pivotably coupled to the detent housing 130. The detent housing 130 may be disposed adjacent to the gear 110 such that the detent 140. More specifically, the detent housing 130 may be disposed to face one end surface of the gear 110 on which the groove 114 is formed.

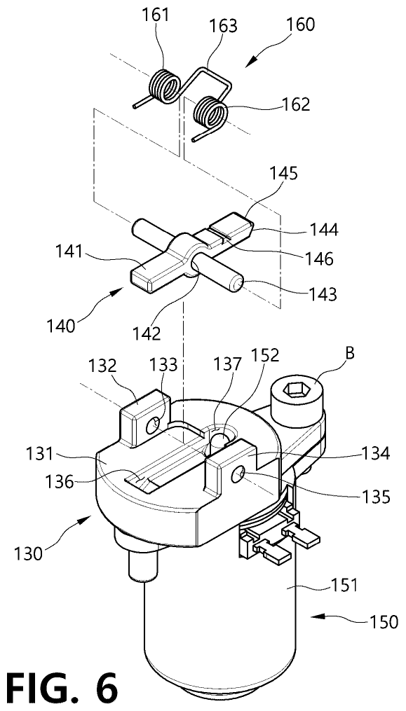

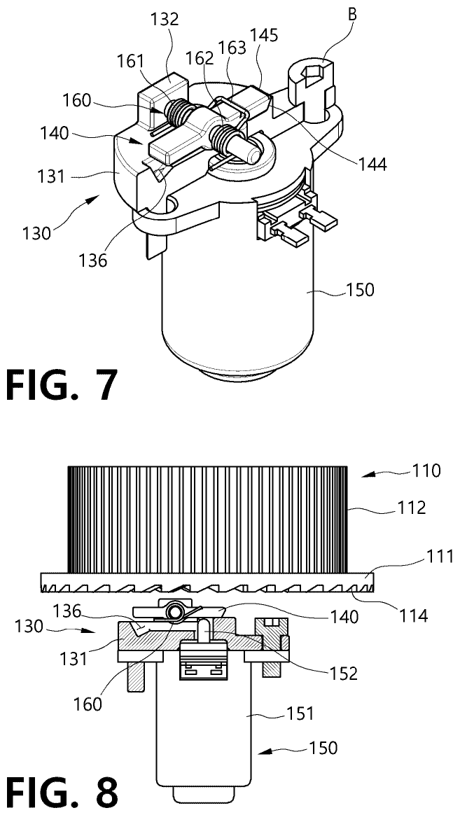

FIG. 6 is a partially exploded view illustrating a detent housing, detent, actuator, and elastic member of an electromechanical brake according to an exemplary embodiment of the present disclosure. FIG. 7 is a partially cut view illustrating a detent housing, detent, actuator, and elastic member of an electromechanical brake according to an exemplary embodiment of the present disclosure.

Referring to FIGS. 6 and 7, the detent housing 130 may include a housing body 131, a first sidewall 132, a second sidewall 134, a pivot guide 136, and a pin guide 137.

The housing body 131 is disposed to face one surface of the gear 110. More specifically, the housing body 131 may be disposed to face one end surface of the gear 110 on which the groove 114 is formed. The housing body 131 may have substantially a plate shape. In this case, one surface of the housing body 131 facing one surface of the gear 110 may be formed to be substantially flat.

In an embodiment of the present disclosure, the housing body 131 may be coupled to the actuator 150. For example, the housing body 131 may be fastened to the actuator 150 through a bolt B. However, the housing body 131 may be fixedly coupled to the actuator 150 by any means such as a fastener or adhesive.

The housing body 131 has the first sidewall 132 such that one end of the pivot shaft 143 of the detent 140 is coupled to the first sidewall 132. The first sidewall 132 may protrude or extend outward from one surface of the housing body 131. One end of the pivot shaft 143 may be inserted into a first through hole 133 formed through the first sidewall 132.

In addition, the housing body 131 has the second sidewall 134 such that the other end of the pivot shaft 143 of the detent 140 is coupled to the second sidewall 134. The second sidewall 134 may protrude or extend outward from one surface of the housing body 131. The first sidewall 132 and the second sidewall 134 face each other. The other end of the pivot shaft 143 may be inserted to a second through hole 135 formed through the second sidewall 134.

The pivot guide 136 is formed in the housing body 131 to accommodate at least a portion of the detent 140. The pivot guide 136 may be configured to guide the pivot of the detent 140 when the detent 140 pivots from the first position (e.g. a disengaged position) to the second position (e.g. an engaged position) around the pivot shaft 143. In an embodiment of the present disclosure, the pivot guide 136 may be recessed from one surface of the housing body 131 facing the gear 110.

The pin guide 137 may be formed to penetrate one surface and the other surface of the housing body 131 so that a pin 152 of the actuator 150 configured to move or pivot the detent 140 from the first position to the second position may be movable within the pin guide 137 to contact the detent 140.

The detent 140 is movably or pivotably coupled to the detent housing 130 to pivot between the first position (e.g. a disengaged position) and the second position (e.g. an engaged position). In an embodiment of the present disclosure, the pivot shaft 143 of the detent 140 may be disposed to pass through the detent 140 in a transverse direction.

FIG. 8 is a view illustrating a disengaged arrangement in which a detent is disengaged from a gear in an electromechanical brake when the detent is positioned at a first position according to an exemplary embodiment of the present disclosure.

Referring to FIG. 8, because the detent 140 is disengaged from the groove 114 of the gear 110 or the detent is not engaged with the gear 110, the detent 140 does not limit the rotation of the gear 110 when the detent is positioned at the first position (e.g. a disengaged position). The first position may be defined as a position where the detent 140 is not engaged with the groove 114 of the gear 110 or is disengaged from the groove 114 of the gear 110. In an embodiment of the present disclosure, the detent 140 positioned at the first position may be disposed substantially parallel to one surface of the housing body 131 of the detent housing 130.

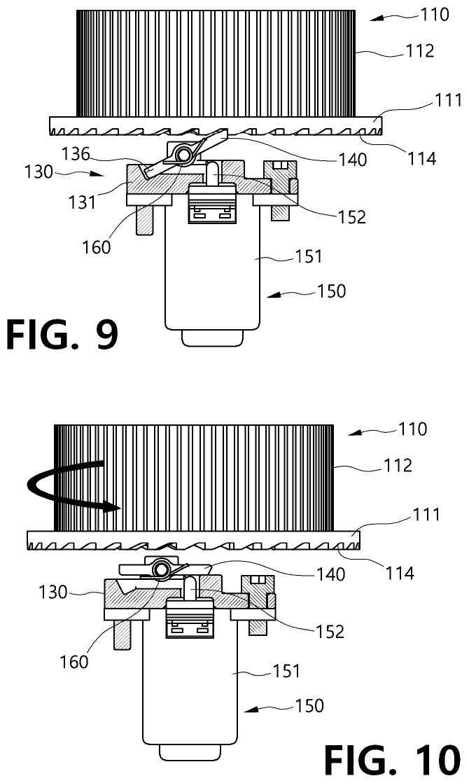

FIG. 9 is a view illustrating an engaged arrangement in which a detent is engaged with a gear in an electromechanical brake when the detent is positioned at a second position according to an exemplary embodiment of the present disclosure.

Referring to FIG. 9, because the detent 140 is engaged with the groove 114 of the gear 110, the detent 140 limits the rotation of the gear 110 at the second position. More specifically, the detent 140 is engaged with the groove 114 of the gear 110 when the detent 140 is positioned at the second position such that the rotation of the gear 110 can be limited. In other words, the second position may be defined as a position where the detent 140 is disposed to be engaged with the groove 114 of the gear 110 to limit the rotation of the gear 110.

Referring back to FIGS. 6 and 7, the detent 140 may have a detent body 141, a pivot shaft arrangement hole 142, a pivot shaft 143, an inclined portion 144, a chamfering portion 145, and a detent groove 146.

The detent body 141 may have, for example, but not limited to, substantially a rod shape. For example, the detent body 141 may have a quadrangular rod shape.

The pivot shaft 143 of the detent 140 is inserted in the pivot shaft arrangement hole 142. The pivot shaft arrangement hole 142 may be formed to pass through the detent body 141 in the transverse direction. For example, the pivot shaft arrangement hole 142 may pass through the detent body 141 in the transverse direction in the middle portion of the detent body 141.

In an embodiment of the present disclosure, the pivot shaft 143 may have substantially a pin shape. In addition, the pivot shaft 143 may be disposed in the pivot shaft arrangement hole 142.

One end of the pivot shaft 143 is disposed in the first through hole 133 of the first sidewall 132 of the detent housing 130 to be coupled to the first sidewall 132, while the other end of the pivot shaft 143 is disposed in the second through hole 135 of the second sidewall 134 of the detent housing 130 to be coupled to the second sidewall 134.

In an embodiment of the present disclosure, the detent 140 includes the pivot shaft arrangement hole 142 that penetrates the detent body 141 in the transverse direction, and has a structure in which the pivot shaft 143 is inserted in the pivot shaft arrangement hole 142. However, this is an exemplary embodiment, and it may also be considered that a pivot shaft 143 may not be provided as a separate part and the pivot shaft 143 may be integrally formed with the detent body 141.

The inclined portion 144 of the detent 140 is formed at one end of the detent body 141 in the longitudinal direction. More specifically, the inclined portion 144 is formed at one end of the detent body 141 that is engaged with the groove 114 of the gear 110 in the second position.

In an embodiment of the present disclosure, the inclined portion 144 of the detent 140 may have a shape in which the distance from the pivot shaft 143 of the detent 140 to the inclined portion 144 in a direction from one surface of detent 140 facing the detent housing 130 to the other surface of the detent 140 facing the gear 110. For example, a distance between the pivot shaft 143 of the detent 140 and a part of the inclined portion 144 of the detent 140 at one surface of the detent 140 facing the gear 110 is longer than another distance between the pivot shaft 143 of the detent 140 and another part of the inclined portion 144 of the detent 140 at another surface of the detent 140 facing the detent housing 130. By having such a structure, when the detent 140 is positioned at the second position, one end of the detent 140 may be securely and stably engaged with the fastening wall 114b of the groove 114 of the gear 110.

Meanwhile, the angle of the inclined portion 144 may be determined in consideration of the arrangement of the detent 140 at the second position and the second angle of the fastening wall 114b of the groove 114 of the gear 110. That is, the angle of the inclined portion 144 may be determined so that one end of the detent 140 may be securely and stably engaged with the fastening wall 114b of the groove 114 when the detent 140 is positioned at the second position.

The chamfering portion 145 is formed at an edge between the inclined portion 144, engaged with the groove 114 of the gear 110 at the second position of the detent body 141, and one surface of the detent body 141 facing the gear 110. The edge between the inclined portion 144, engaged with the groove 114 when the detent body 141 is positioned at the second position, and one surface of the detent body 141 facing the gear 110 is a portion which is inserted into the groove 114 of the gear 110 when the detent 140 pivots from the first position to the second position. Therefore, the chamfering portion 145 disposed at the edge of the detent 140 may cause the detent 140 to be smoothly inserted into the inside of the groove 114 of the gear 110 when pivoting from the first position to the second position.

The detent groove 146 is formed so that a connection part 163 of the elastic member 160, which will be described later, is seated or disposed in the detent groove 146. The detent groove 146 causes the connection part 163 of the elastic member 160 to stably press the detent 140.

The detent groove 146 may be recessed from one surface of the detent body 141 that faces the gear 110. The detent groove 146 may be formed transversely across the detent 140.

The actuator 150 moves or pivots the detent 140 from the first position (i.e. a disengaged position) to the second position (i.e. an engaged position). The actuator 150 moves or pivots the detent 140 from the first position to the second position during the parking braking of the vehicle so that the detent 140 can be engaged with the gear 110. Accordingly, the parking braking state may be prevented to be released due to the reverse rotation of the gear 110 caused by an unintended impact, etc. while the vehicle's parking brake is fastened.

The actuator 150 may include, for example, but not limited to, a solenoid 151 and a pin 152. The pin 152 is configured to be displaceable with respect to the solenoid 151. For example, when power is applied to the solenoid 151, the pin 152 may move toward the outside of the solenoid 151 along the longitudinal axis of the solenoid 151 (for example, toward the gear 110), and when power is not applied to the solenoid 151, the pin 152 may move toward the inside of the solenoid 151 along the longitudinal axis of the solenoid 151 (for instance, in a direction of being away from the gear 110).

When the vehicle's parking braking is being performed, power is applied to the solenoid 151 so that the pin 152 move outwardly from the solenoid 141 and pushes or presses one end of the detent 140 so that the detent 140 may pivot from the first position (i.e. a disengaged position) to the second position (i.e. an engaged position). Accordingly, the detent 140 is pivoted from the first position to the second position and then is engaged with the groove 114 of the gear 110. After the detent 140 is engaged with the groove 114 of the gear 110, the power may not be supplied to the solenoid 151. When the application of power to the solenoid 151 is stopped, the pin 152 may move back to the inside of the solenoid 151.

As discussed above, the actuator 150 may be coupled to the detent housing 130. More specifically, the end of the actuator 150 where the pin 152 of the actuator 150 can move outwardly may be coupled to the detent housing 130. In this case, the pin 152 of the actuator 150 may be displaced within the pin guide 137 of the detent housing 130.

The actuator 150 may be controlled by the controller 170. That is, according to the control of the controller 170, power may be applied to the solenoid 151 or power supplied to the solenoid 151 may be cut off.

The elastic member or component 160 is configured to apply an elastic force to the detent 140 toward the detent housing 130 to move the detent 140 in a direction from the second position toward the first position. In an embodiment of the present disclosure, the elastic member 160 may be configured to press one surface of the detent 140 facing the gear 110 toward the detent housing 130.

When releasing the parking brake of the vehicle, the detent 140 needs to be disengaged from the groove 114 of the gear 110. In other words, the detent 140 must be pivoted from the second position (i.e. an engaged position) to the first position (i.e. a disengaged position). When releasing the parking brake, the elastic member 160 moves or presses the detent 140 in a direction of being away from the gear 110 (e.g. in a direction from the second position toward the first position, thereby supporting the returning of the detent 140 to the first position so that the detent 140 can be disengaged from the groove 114 of the gear 110 during the operation of releasing the parking brake.

Referring back to FIGS. 6 and 7, the elastic member 160 may include a first fixing part 161, a second fixing part 162, and a connection part 163.

The first fixing part 161 of the elastic member 160 is coupled to the pivot shaft 143 of the detent 140 on one side of the detent 140 in the transverse direction. In an embodiment of the present disclosure, the first fixing part 161 of the elastic member 160 may be coupled to the pivot shaft 143 on one side of the detent 140 in the transverse direction. The first fixing part 161 of the elastic member 160 may be, for example, but not limited to, a coil spring wound around the outer circumferential surface of the pivot shaft 143.

In this case, one end of the first fixing part 161 may extend to be parallel to one surface of the housing body 131 of the detent housing 130, and the other end of the first fixing part 161 may extend to form a predetermined angle with one surface of the housing body 131. The other end of the first fixing part 161 is connected to the connection part 163.

The second fixing part 162 of the elastic member 160 is coupled to the pivot shaft 143 of the detent 140 on the other side of the detent 140 in the transverse direction. In an embodiment of the present disclosure, the second fixing part 162 of the elastic member 160 may be coupled to the pivot shaft 143 on the other side of the detent 140 in the transverse direction. The second fixing part 162 may be, for example, but not limited to, a coil spring wound around the outer circumferential surface of the pivot shaft 143.

In this case, one end of the second fixing part 162 may extend to be parallel to one surface of the housing body 131 of the detent housing 130, and the other end of the second fixing part 162 may extend to form a predetermined angle with one surface of the housing body 131. The other end of the second fixing part 162 is connected to the connection part 163.

The connection part 163 extends to connect between the first fixing part 161 and the second fixing part 162. The connection part 163 may be configured to presse one surface of the detent 140 facing the gear 110 in a direction of being away from the gear 110. In an embodiment of the present disclosure, the connection part 163 may be formed by extending and bending the other end of the first fixing part 161 and the other end of the second fixing part 162, respectively, formed of coil springs.

In this way, the elastic member 160 is coupled to the pivot shaft 143 of the detent 140 on both one side and the other side of the detent 140 and is arranged to press one surface of the detent 140 facing the gear 110 toward the detent housing 130. Accordingly, when the detent 140 engaged with the groove 114 of the gear 110 in the parking braking state is released from the state of engagement with the groove 114 during the operation of releasing the parking brake, the elastic member 160 may press and guide the detent 140 so that the detent 140 may be stably pivoted from the second position to the first position. As a result, the return of the detent 140 from the second position to the first position can be performed reliably and stably.

The controller 170 controls the motor 120 and the actuator 150. For example, the controller 170 may comprise one or more processors or chips and memory, and be mounted to a printed circuit board (PCB). In an embodiment of the present disclosure, the controller 170 may be disposed behind the gear 110 and the actuator 150 and covered by the second housing cover 105b. Meanwhile, the controller 170 may receive signals for controlling the motor 120 and the actuator 150 from an upper level ECU or a central ECU of the vehicle.

FIGS. 10 to 13 are views illustrating an operation process of applying parking braking of an electromechanical brake according to an exemplary embodiment of the present disclosure. Referring to FIGS. 10 to 13, the operation process of applying the parking braking of an electromechanical brake according to an exemplary embodiment of the present disclosure will be discussed as follows.

First, referring to FIG. 10, the gear 110 rotates in a first direction. Here, the first direction refers to a direction in which braking force is generated by the driving mechanism 106 as the gear 110 rotates.

In this case, the controller 170 may control the motor 120 to rotate the gear 110 in the first direction. The controller 170 may control the motor 120 such that the gear 110 rotates in the first direction until appropriate parking braking force is secured or parking brake force equal to or more than a predetermined force is applied.

Next, referring to FIG. 11, the gear 110 rotates in a second direction opposite to the first direction. Here, the second direction refers to a direction in which the driving mechanism 106 operates to release the braking state as the gear 110 rotates.

In this case, the controller 170 controls the motor 120 to rotate the gear 110 in the second direction. The controller 170 may control the motor 120 so that the gear 110 rotates in the second direction to a predetermined degree while maintaining the parking braking force, considering that the detent 140 will engage the groove 114 of the gear 110 and the gear 110 will rotate to a predetermined degree in one direction later.

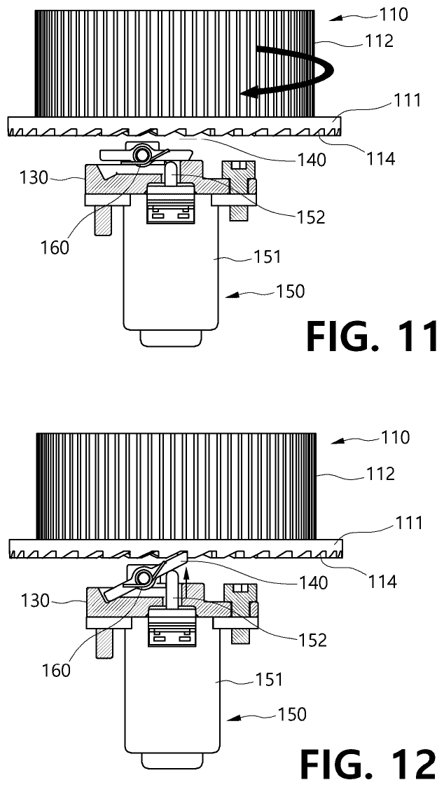

Next, referring to FIG. 12, the controller 170 controls the actuator 150 to move or pivot the detent 140 from the first position (i.e. a disengaged position) to the second position (i.e. an engaged position). For example, the controller 170 may apply power to the solenoid 151 so that the pin 152 moves outwardly from the solenoid 151 and pushes the detent 140 toward the gear 110 to pivot the detent 140 from the first position to the second position.

Meanwhile, when the actuator 150 is actuated or operated, the actuator 150 move the pin 152 by applying the pressing force to the detent 140 greater than the elastic force of the elastic member 160. Accordingly, the detent 140 may be pivoted from the first position to the second position by overcoming the elastic force of the elastic member 160.

The detent 140 is engaged with the groove 114 of the gear 110 at the second position. As the detent 140 is engaged with the groove 114, the gear 110 may be rotated to a predetermined degree in the first direction. In addition, once the detent 140 is engaged with the groove 114, the rotation of the gear 110 in the second direction is limited. Accordingly, the release of the parking braking state caused by unintended rotation of the gear 110 when the parking braking is applied can be prevented.

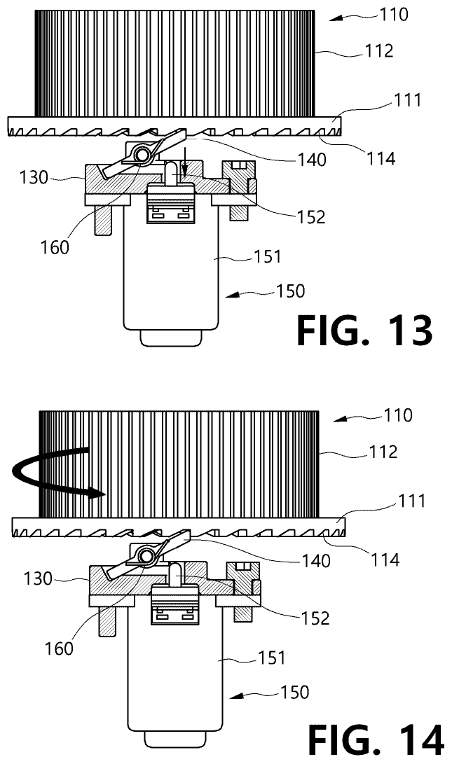

Finally, referring to FIG. 13, the controller 170 controls the actuator 150 to return the pin 152 to an original position. For example, the controller 170 stops power being applied to the solenoid 151 to displace the pin 152 toward the solenoid 151.

If the pin 152 remains in a state that the pin 152 is moved outwardly from the solenoid 151, the detent 140 may not pivot from the second position to the first position even when the parking braking state is later released. Therefore, once the detent 140 is engaged with the groove 114 of the gear 110, the pin 152 needs to be returned toward the solenoid 151. Accordingly, the controller 170 controls the actuator 150 as described above.

FIGS. 14 to 16 are views illustrating an operation process of releasing parking braking of an electromechanical brake according to an exemplary embodiment of the present disclosure. Referring to FIGS. 14 to 16, the operation process of releasing parking braking of the electromechanical brake according to an exemplary embodiment of the present disclosure will be discussed below.

First, referring to FIG. 14, the gear 110 rotates in a first direction. The controller 170 may control the motor 120 to rotate the gear 110 in the first direction. Accordingly, by the rotation of the gear 110 in the first direction, the engagement between the detent 140 and the groove 114 of the gear 110 may be released.

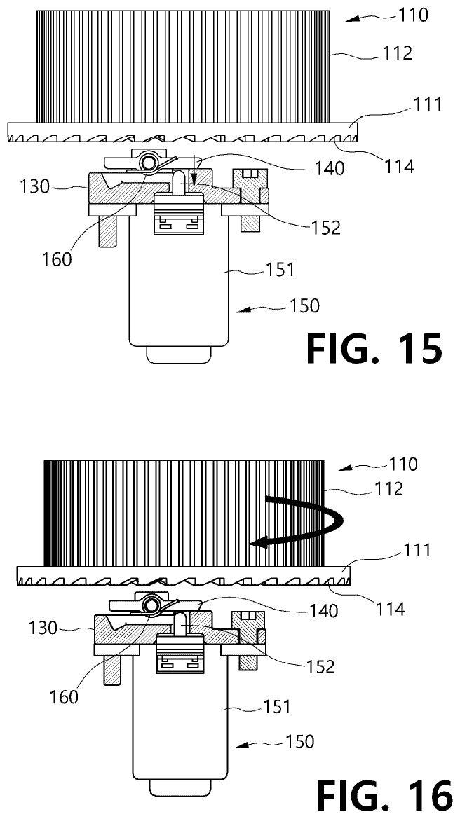

Next, referring to FIG. 15, the detent 140 is pivoted from the second position (i.e. an engaged position) to the first position (i.e. a disengaged position). When the engagement between the detent 140 and the groove 114 of the gear 110 is released, the detent 140 is moved by the elastic force of the elastic member 160 toward the detent housing 130. In this case, the elastic force of the elastic member 160 is applied to the detent 140 in a direction from the second position to the first position. Accordingly, the detent 140 can pivot from the second position to the first position.

Finally, referring to FIG. 16, the gear 110 rotates in the second direction. Accordingly, the driving mechanism 106 operates in a direction of releasing the parking braking force, and therefore the parking braking state is released. In this case, the controller 170 may control the motor 120 to rotate the gear 110 in the second direction.

Hereinafter, a method for operating an electromechanical brake according to an embodiment of the present disclosure will be described.

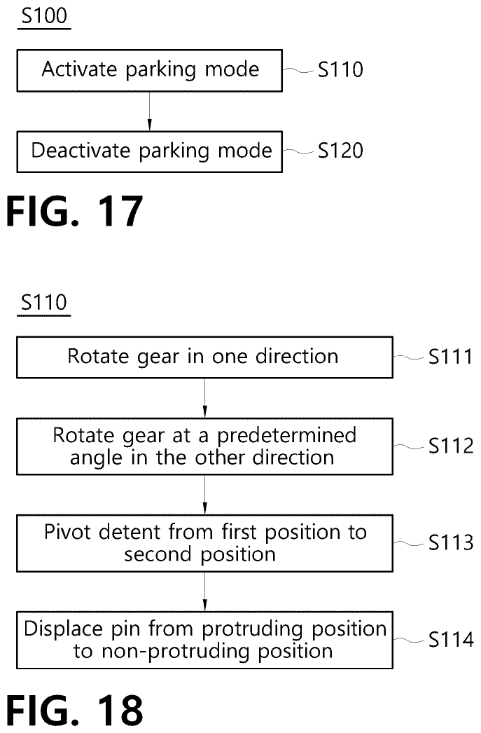

FIG. 17 is a flowchart for illustrating a method for operating an electromechanical brake according to an exemplary embodiment of the present disclosure. A method S100 for operating an electromechanical brake according to an embodiment of the present disclosure is for performing the parking braking or releasing the parking braking through the electromechanical brake 100 according to an embodiment of the present disclosure described above.

Referring to FIG. 17, the method S100 for operating the electromechanical brake according to an embodiment of the present disclosure includes step S110 of activating a parking mode and step S120 of deactivating a parking mode.

FIG. 18 is a flowchart for illustrating a step of activating a parking mode in a method for operating an electromechanical brake according to an exemplary embodiment of the present disclosure.

Referring to FIG. 18, an exemplary embodiment of step S110 of activating the parking mode may be performed as follows.

First, at step S111, the gear 110 rotates in a first direction according to the operation of the motor 120 so that the braking force is generated. Step S111 may be the same as or similar to the operation described with reference to FIG. 10.

Next, at step S112, the gear 110 rotates at a predetermined angle in a second direction according to the operation of the motor 120. Step S112 may be the same as or similar to the operation described with reference to FIG. 11.

Next, at step S113, the pin 152 is displaced from a position not protruded to another position protruded according to the operation of the actuator 150, so that the detent 140 pivots from the first position to the second position. Step 113 may be the same as or similar to the operation described with reference to FIG. 12.

Finally, at step S114, the pin 152 is displaced from the position protruded to the position not protruded according to the operation of the actuator 150. Step S114 may be the same as or similar to the operation described with reference to FIG. 13.

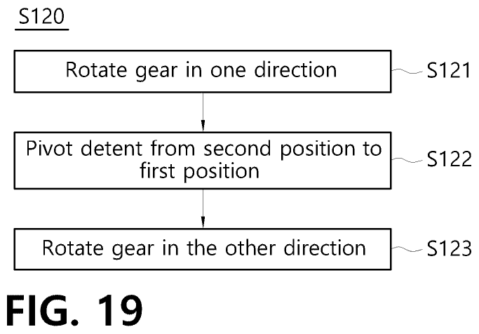

FIG. 19 is a flowchart illustrating a step of deactivating parking mode in a method for operating an electromechanical brake according to an exemplary embodiment of the present disclosure.

Referring to FIG. 19, step S120 of deactivating the parking mode may be performed as follows to deactivate the parking braking mode after activating the parking braking mode.

First, at step S121, the gear 110 rotates in a first direction according to the operation of the motor 120. Step S121 may be the same as or similar to the operation described with reference to FIG. 14.

Next, at step S122, the engagement between the detent 140 and the groove 114 is released, and the detent 140 pivots from the second position to the first position by the elastic force of the elastic member 160. Step S212 may be the same as or similar to the operation described with reference to FIG. 15.

Finally, at step S123, the gear 110 rotates in the second direction opposite to the first direction according to the operation of the motor 120 so that the braking force is released. Step S123 may be the same as or similar to the operation described with reference to FIG. 16.

The electromechanical brake and the method for operating the same according to some embodiments of the present disclosure may enable a detent, which has been displaced from a first position to a second position, to be reliably and stably returned to the first position by an elastic force of an elastic member pressing the detent from the second position to the first position when parking brake is released in order to prevent a gear transmitting the actuator's torque upon the parking braking from rotating reversely after the parking braking.

In addition, the electromechanical brake and the method for operating the same according to certain embodiments of the present disclosure may enable the pivot of a detent to be stable along a consistent path through a detent housing having an elastic member configured to press one surface of the detent and a pivot shaft of the detent and guiding the pivot of the detent.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. An electromechanical brake, comprising:
a gear configured to rotate to apply or release a brake, the gear having one or more grooves;
a detent housing;
a detent pivotably coupled to the detent housing to pivot between a disengaged position in which the detent is not engaged with the grooves of the gear not to limit rotation of the gear and an engaged position in which the detent is engaged with one of the grooves of the gear to limit the rotation of the gear;
an actuator configured to cause the detent to be pivoted from the disengaged position to the engaged position such that the detent is engaged with one of the grooves of the gear; and
an elastic member configured to apply an elastic force to the detent in a direction from the engaged position toward the disengaged position.

2. The electromechanical brake of claim 1, wherein the detent comprises a detent body having a detent hole.

3. The electromechanical brake of claim 2, further comprising a pivot shaft inserted in the detent hole and coupled to the detent housing.

4. The electromechanical brake of claim 1, further comprising a pivot shaft formed integrally with the detent.

5. The electromechanical brake of claim 1, wherein the detent comprises an inclined portion at one end of the detent which is engaged with one of the grooves when the detent is pivoted to the engaged position.

6. The electromechanical brake of claim 5, wherein the inclined portion of the detent has a shape in which a distance between the pivot shaft of the detent and a part of the inclined portion of the detent at one surface of the detent facing the gear is longer than another distance between the pivot shaft of the detent and another part of the inclined portion of the detent at another surface of the detent facing the detent housing.

7. The electromechanical brake of claim 1, wherein the detent has a chamfering portion formed at an edge between one surface of the detent facing the gear and one end of the detent which is engaged with one of the grooves when the detent is pivoted to the engaged position.

8. The electromechanical brake of claim 1, wherein the elastic member comprises:
a first fixing part coupled to a pivot shaft of the detent on one side of the detent,
a second fixing part coupled to the pivot shaft on another side of the detent, and
a connection part connecting between the first fixing part and the second fixing part and configured to press one surface of the detent facing the gear in the direction from the engaged position toward the disengaged position.

9. The electromechanical brake of claim 8, wherein the connection part of the elastic member is inserted in a detent groove formed on the one surface of the detent facing the gear.

10. The electromechanical brake of claim 9, wherein the detent groove is formed transversely across the detent.

11. The electromechanical brake of claim 1, wherein the detent housing comprises:
a first sidewall coupled to one end of a pivot shaft of the detent, and
a second sidewall coupled to another end of the pivot shaft.

12. The electromechanical brake of claim 11, wherein the detent housing further comprises a pivot guide accommodating at least a portion of the detent in the pivot guide and configured to guide pivoting of the detent around the pivot shaft.

13. An electromechanical brake, comprising:
a gear configured to rotate to apply or release a brake force, the gear having one or more grooves;
a motor operably connected to the gear to rotate the gear;
a detent housing;
a detent pivotably coupled to the detent housing to pivot between a disengaged position in which the detent is not engaged with the grooves of the gear not to limit rotation of the gear and an engaged position in which the detent is engaged with one of the grooves of the gear to limit the rotation of the gear;
an actuator configured to cause the detent to be pivoted from the disengaged position to the engaged position such that the detent is engaged with one of the grooves of the gear;
an elastic member configured to apply an elastic force to the detent in a direction from the engaged position toward the disengaged position; and
a controller configured to control the motor and the actuator.

14. The electromechanical brake of claim 13, wherein the controller is configured to, in response to a signal for applying parking brake, control the motor to rotate the gear in a first direction for applying the brake force, control the motor to rotate the gear to a predetermined degree in a second direction opposite to the first direction, and control the actuator to pivot the detent from the disengaged position to the engaged position such that the detent is engaged with the one of the grooves.

15. The electromechanical brake of claim 13, wherein the controller is configured to, in response to a signal for releasing parking brake, control the motor to rotate the gear in the first direction for applying the brake force so that the detent is disengaged from one of the grooves of the gear and pivoted from the engaged position to the disengaged position by the elastic force of the elastic member.

16. A method for operating an electromechanical brake, the method comprising:
in response to a signal for applying parking brake, rotating a gear having one or more grooves in a first direction for applying brake force by a motor operably connected to the gear;
rotating the gear at a predetermined angle in a second direction opposite to the first direction by the motor;
pivoting the detent from a disengaged position in which the detent is not engaged with the grooves of the gear to an engaged position in which the detent is engaged with one of the grooves of the gear by moving a pin of an actuator in a direction toward the gear; and
after the detent is engaged with the one of the grooves of the gear, moving the pin of the actuator in a direction of being away from the gear.

17. The method of claim 16, further comprising:
in response to a signal for releasing the parking brake, disengaging the detent from the one of the grooves by rotating the gear in the first direction for applying the brake force;
pivoting the detent from the engaged position to the disengaged position by an elastic force of an elastic member; and
rotating the gear in the second direction for releasing the brake force by the motor.
